(19) United States
(12) Patent Application Publication
(10) Pub. No.: US 2026/0304143 A1
(43) Pub. Date: Oct. 1, 2026

(54) METHOD AND APPARATUS FOR FORMING A USER CENTRIC CLUSTER

(71) Applicant: Samsung Electronics Co., Ltd., Gyeonggi-do (KR)

(72) Inventors: Abhishek CHATURVEDI, Bangalore (IN); Manasi EKKUNDI, Bangalore (IN); Neha SHARMA, Bangalore (IN); Dongmyung KIM, Gyeonggi-do (KR)

(21) Appl. No.: 19/489,119

(22) PCT Filed: May 27, 2024
(86) PCT No.: PCT/KR2024/007133

§ 371 Date: Dec. 1, 2025

(30) Foreign Application Priority Data
May 30, 2023 (IN) 202341037260
Apr. 16, 2024 (IN) 202341037260

(51) Int. Cl. H04W 16/20; H04L 5/00

(52) U.S. Cl. CPC H04W 16/20; H04L 5/0048

(57) ABSTRACT

The disclosure relates to a 5G or 6G communication system for supporting a higher data transmission rate. The present invention generally relates to the field of femtocell, and more specifically relates to a method and a system for forming a User Centric Cluster (UCC) for at least one Cell Free (CF) femtocell deployment.

### TECHNICAL FIELD

The present invention generally relates to the field of femtocell, and more specifically relates to a method and a system for forming a User Centric Cluster (UCC) for at least one Cell Free (CF) femtocell deployment.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

A femtocell, also referred to as a “home base station”, is a small-scale wireless cellular access point that facilitates connectivity between standard mobile devices and a mobile operator's network by utilizing, for example, a Digital Subscriber Line (DSL), optical fibers, or cable broadband internet connections, as illustrated in FIG. 1. Femtocells are deployed to improve indoor cellular coverage and address signal deficiencies in areas with weak connectivity to one or more primary network cells. Additionally, the femtocells alleviate congestion on the one or more primary network cells by establishing a connection from the standard mobile devices (end users), through an internet connection, to an operator's private network infrastructure at a different location. Originally, femtocell services were introduced during a 3G era, the femtocell services are now available with 4G and the latest 5G wireless communication systems. Many operators globally provide the femtocell services, primarily catering to businesses and individuals experiencing poor signal quality at their premises. While a standard base station can cover a range of up to 35 kilometers, the coverage of the femtocell is limited to tens of meters.

In addition, the 5G wireless communication systems deliver ultra-reliability and support low-latency applications. Research efforts are already underway to define the requirements, systems, and frameworks of 6G wireless communication systems, aiming to overcome the limitations of 5G and accommodate advanced use cases. High-frequency ranges, such as centimetric (7-15 GHz) and sub-THz (90-300 GHz), are being considered as potential candidates for the 6G wireless communication systems. These frequencies necessitate narrow beams for transmission and reception to mitigate interference from neighboring base stations and extend the range of a 6G link. However, reliable transmission at higher frequencies faces significant challenges due to high path loss, heavy shadowing, rain attenuation, and anticipated that a 6G macro cell may face weak or no signal issues, particularly in indoor coverage scenarios.

To address the aforementioned challenges, the concept of a 6G Cell Free (CF) based femtocell architecture revolves around an integration of multiple Transmission Reception Points (TRPs) per cell, representing a departure from the traditional design principles governing cellular systems, for example, including those employed in 5G wireless communication systems. This new architecture aims to create a User Centric Cluster (UCC)/cluster within each cell or area, ensuring continuous radio coverage through the integration of multiple TRPs, as illustrated in FIG. 2.

In addition, the advancement of indoor cellular technologies will drive the development of 6G CF-based femtocell architecture or said 6G technology-based femtocells. The 6G technology-based femtocells are expected to provide broadband-equivalent services, boasting peak data rates of 1 Tbps, a bandwidth capacity of 100 GHz, and exceptionally high spectral efficiency. Moreover, the distributed network architecture of 6G technology-based femtocells, including the Central Unit (CU), Distributed Unit (DU), Radio Unit (RU), and others, aligned with a 5G distributed network, combined with the cell-free (multiple TRPs) based design, necessitates a thorough exploration of various deployment options for a 6G cell-free-based femtocell. Additionally, the efficient realization of the UCC/cluster within a 6G cell-free design, equipped with the flexibility of multiple TRP installations, is currently a focal point of research. As the 6G CF-based femtocell architecture is anticipated to operate in high-end spectrums such as centimetric (7-15 GHz) and sub-THz (90-300 GHz), there is a requirement to explore the realization of the 6G CF-based femtocell architecture.

In other words, advent of 6G cellular technology, the progression to 6G-based femtocell infrastructure represents the next phase in the evolution of indoor cellular technologies. This advancement is poised to deliver superior broadband-equivalent services, including peak data rates of 1 Tbps, a bandwidth capacity of 100 GHz, and exceptionally high spectral efficiency. Notably, the concept of “multi TRP” is currently in its infancy within the 3GPP NR framework, while the theoretical and practical realization of “cell free” with cluster formation remains absent from industry standards (3GPP standards). As a result, it is essential to proactively identify potential challenges and devise tailored solutions to address the unique demands of femtocell scenarios.

Thus, it is desired to address the above-mentioned disadvantages or other shortcomings or at least provide a useful alternative for forming the UCC for at least one CF femtocell deployment.

### DISCLOSURE OF INVENTION

### Technical Problem

In line with development of the communication systems, there is a need for forming a User Centric Cluster (UCC) for at least one Cell Free (CF) femtocell deployment.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

According to one embodiment of the present disclosure, a method for forming a User Centric Cluster (UCC) for at least one Cell Free (CF) femtocell deployment is disclosed herein. The method includes receiving one or more network parameters from a User Equipment (UE) at a network entity, wherein the network entity comprises at least one of multiple Transmission Reception Points (TRPs) and a TRP Controller (TRP-C), wherein the one or more network parameters comprise Channel State Information Reference Signal (CSI-RS) information, Transmission Configuration Indicator (TCI) state measurement information, Uplink (UL) pilot signal information, and location sensing information. The method further includes processing the one or more received network parameters at the network entity comprising a centralized processing at the TRP-C and a localized processing at each TRP associated with the multiple TRPs. The method further includes forming the UCC for the at least one CF femtocell deployment based on at least one of the centralized processing at the TRP-C and the localized processing at the multiple TRPs.

According to another embodiment of the present disclosure, the network entity for forming the UCC for the at least one CF femtocell deployment. The network entity includes a processor coupled with a memory and a communicator. The processor is configured to receive the one or more network parameters from the UE at the network entity, wherein the network entity comprises the at least one of multiple TRPs, and the TRP-C, wherein the one or more network parameters comprise the CSI-RS information, the TCI state measurement information, the UL pilot signal information, and the location-sensing information. The processor is further configured to process the one or more received network parameters at the network entity comprising the centralized processing at the TRP-C and the localized processing at each TRP associated with the multiple TRPs. The processor is further configured to form the UCC for the at least one CF femtocell deployment based on at least one of the centralized processing at the TRP-C and the localized processing at the multiple TRPs.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### Advantageous Effects of Invention

The present disclosure provides an effective and efficient method for forming a User Centric Cluster (UCC) for at least one Cell Free (CF) femtocell deployment. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a conventional femtocell architecture;

FIG. 2 illustrates a Multi-TRP based 6G cell-free architecture;

FIG. 3 illustrates a block diagram of a network entity for forming a User Centric Cluster (UCC) for at least one Cell Free (CF) femtocell deployment, according to an embodiment as disclosed herein;

FIGS. 4A, 4B, 4C, 4D, and 4E illustrate exemplary scenarios for designing the CF femtocell deployment, according to an embodiment as disclosed herein;

FIG. 5 is a sequence flow diagram illustrating a method for forming the UCC for the CF femtocell deployment based on centralized processing at a TRP Controller (TRP-C), according to an embodiment as disclosed herein;

FIGS. 6A, 6B, 6C, and 6D illustrate one or more operations associated with a method for forming the UCC for the CF femtocell deployment based on localized processing at each TRP associated with the multiple TRPs, according to an embodiment as disclosed herein;

FIG. 7 is a sequence flow diagram illustrating a method for forming the UCC for the CF femtocell deployment based on the centralized processing at the TRP-C and Uplink (UL) pilot signal information, according to an embodiment as disclosed herein;

FIGS. 8A and 8B illustrate one or more operations associated with a method for forming the UCC for the CF femtocell deployment based on the localized processing at each TRP associated with the multiple TRPs and the UL pilot signal information, according to an embodiment as disclosed herein;

FIG. 9 illustrates one or more operations associated with a method for forming the UCC for the CF femtocell deployment based on location sensing information, according to an embodiment as disclosed herein;

FIGS. 10A, 10B, 10C, and 10D illustrate one or more operations associated with a method for forming the UCC with multiple TRPs connected across multiple Distributed Units (DUs), according to an embodiment as disclosed herein; and

FIG. 11 is a flow diagram illustrating a method for forming the UCC for at least one CF femtocell deployment, according to an embodiment as disclosed herein.

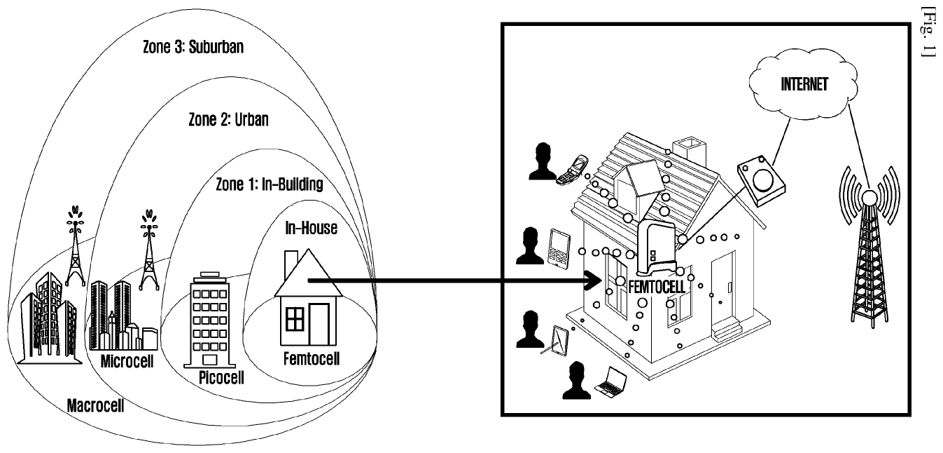

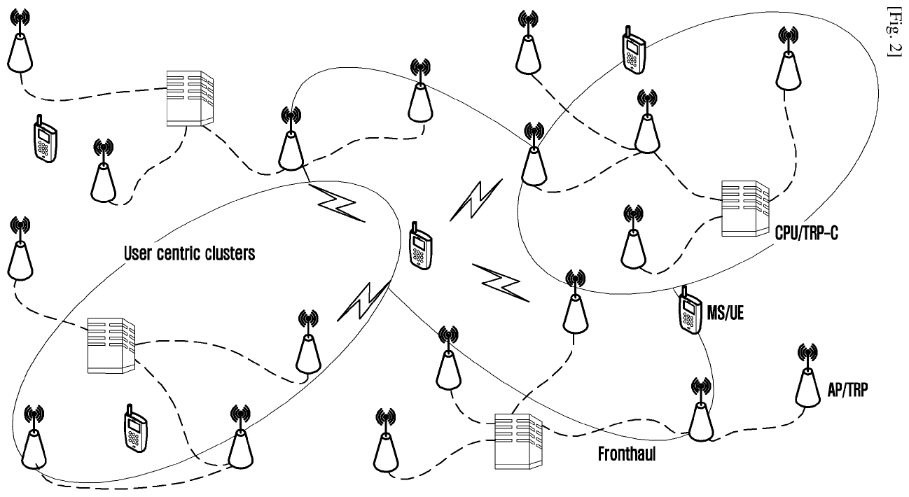

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

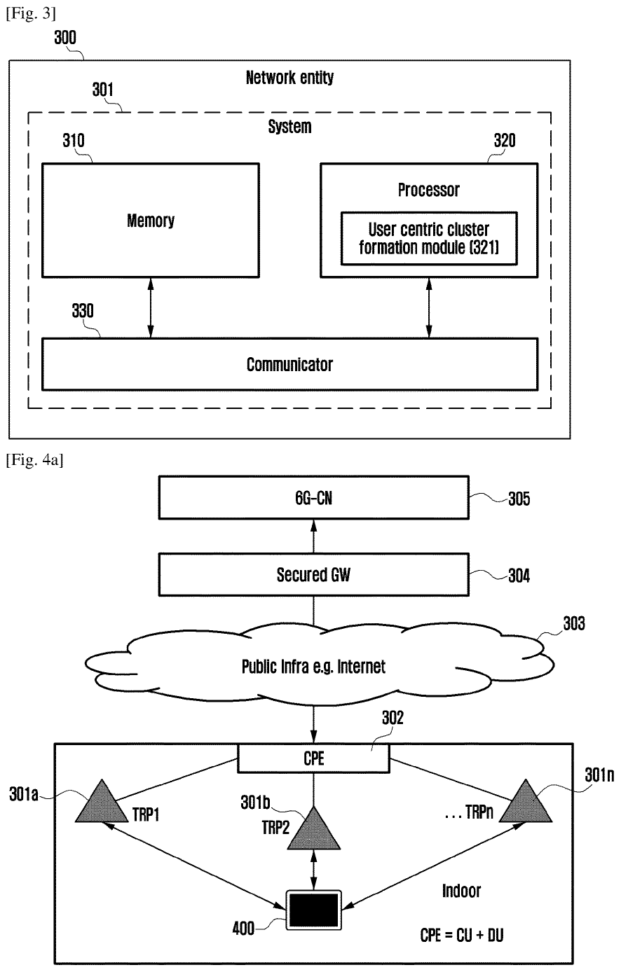

Referring now to the drawings, and more particularly to FIGS. 3 to 11, where similar reference characters denote corresponding features consistently throughout the figures, there are shown preferred embodiments.

FIG. 3 illustrates a block diagram of a network entity 300 for forming a User Centric Cluster (UCC) for at least one Cell Free (CF) femtocell deployment, according to an embodiment as disclosed herein. Examples of the network entity 300 may include, but are not limited to a Transmission Reception Point (TRP), a TRP Controller (TRP-C), a Distributed Unit (DU), a Centralized Unit (CU), any server, etc.

In an embodiment, the network entity 300 comprises a system 301. The system 301 may include a memory 310, a processor 320, and a communicator 330. In one or more embodiments, the system 301 may be implemented on one or more network entities (not shown in FIG. 3).

In an embodiment, the memory 310 stores instructions to be executed by the processor 320 for forming the UCC for the at least one CF femtocell deployment, as discussed throughout the disclosure. The memory 310 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 310 may, in some examples, be considered a non-transitory storage medium. The term “non-transitory” may indicate that the storage medium is not embodied in a carrier wave or a propagated signal. However, the term “non-transitory” should not be interpreted that the memory 310 is non-movable. In some examples, the memory 310 can be configured to store larger amounts of information than the memory. In certain examples, a non-transitory storage medium may store data that can, over time, change (e.g., in Random Access Memory (RAM) or cache). The memory 310 can be an internal storage unit, or it can be an external storage unit of the network entity 300, a cloud storage, or any other type of external storage.

The processor 320 communicates with the memory 310 and the communicator 330. The processor 320 is configured to execute instructions stored in the memory 310 and to perform various processes for forming the UCC for the at least one CF femtocell deployment, as discussed throughout the disclosure. The processor 320 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

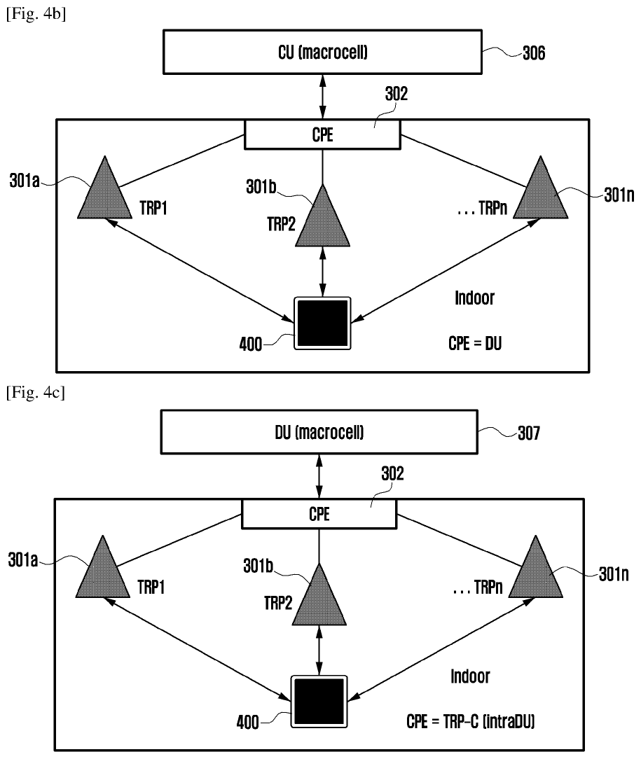

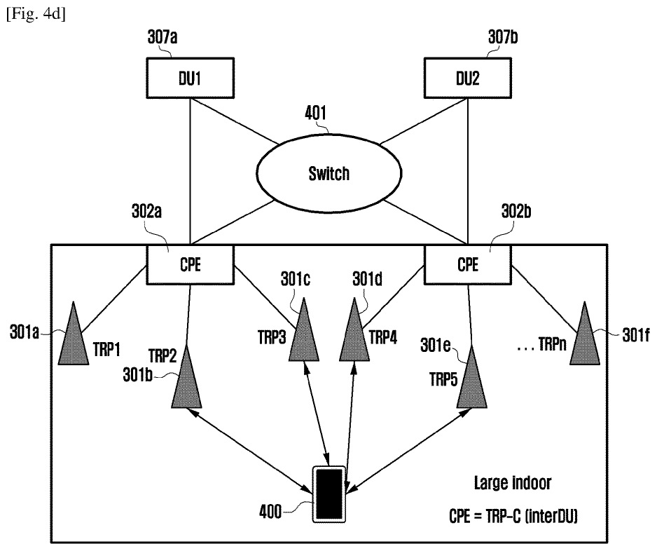

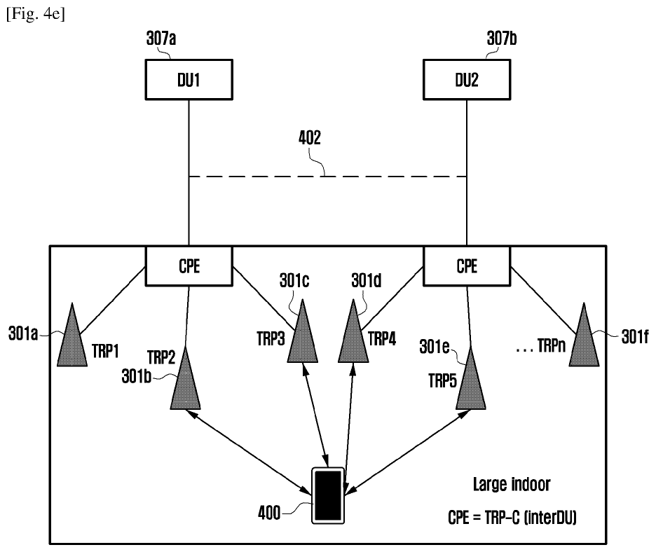

In one embodiment, the processor 320 may include a user centric cluster formation module 321. The user centric cluster formation module 321 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The user centric cluster formation module 321 may execute multiple operations to form the UCC for the at least one CF femtocell deployment, which are given below. Examples of various CF femtocell deployments are illustrated in FIGS. 4A, 4B, 4C, 4D, and 4E.

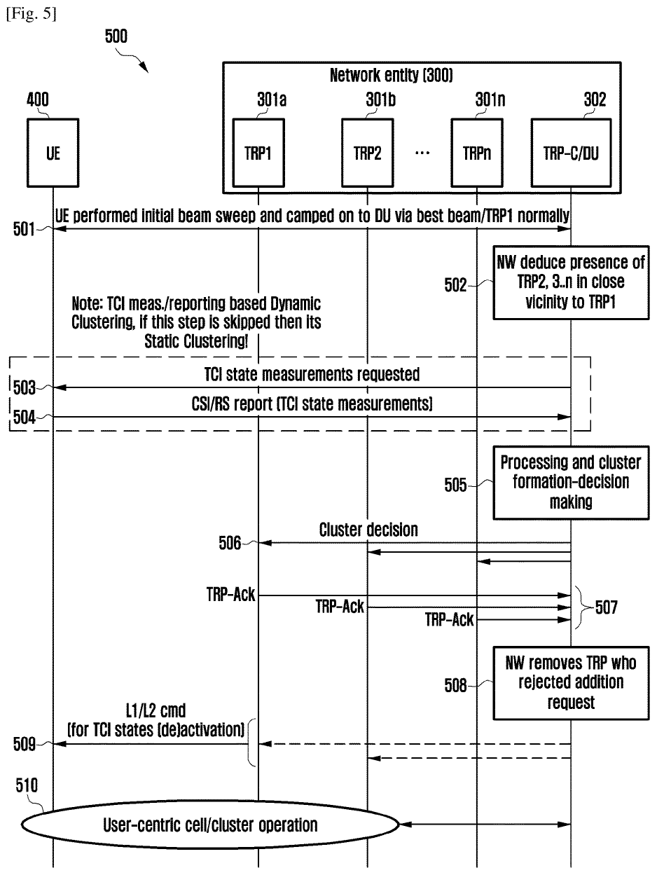

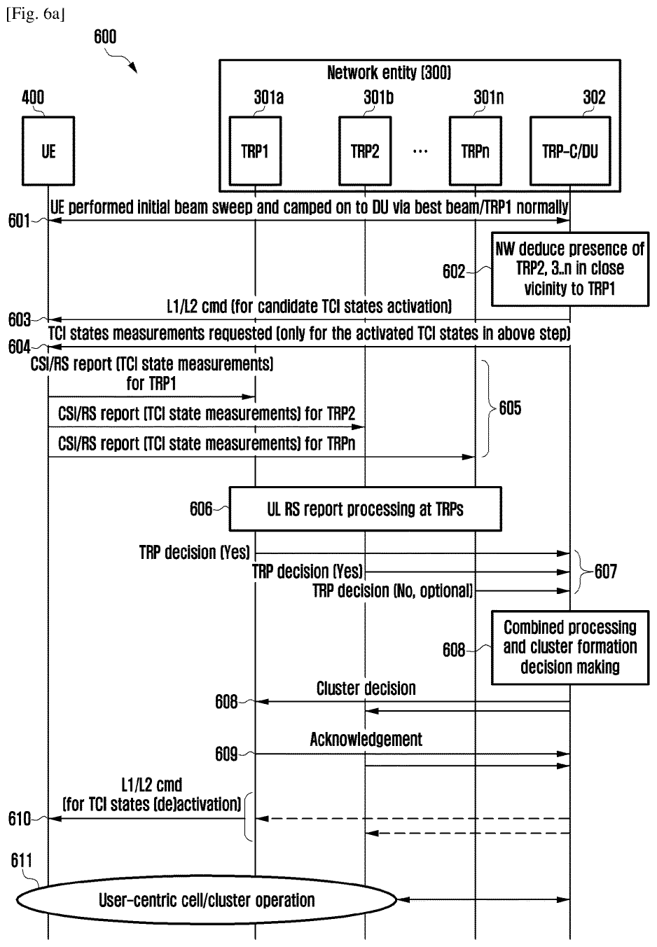

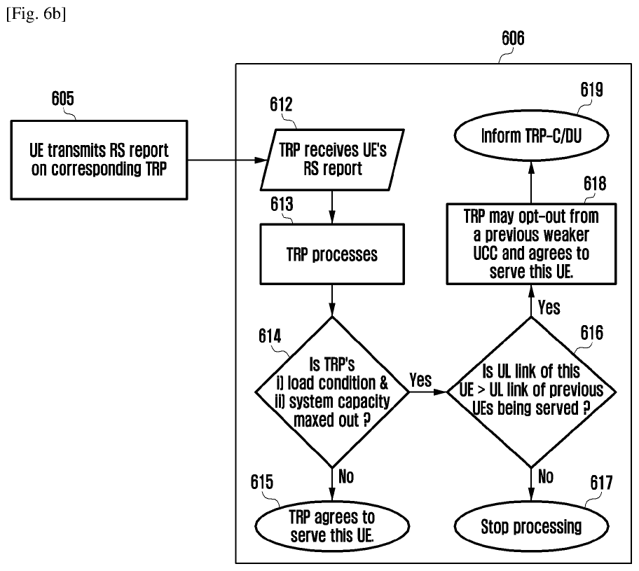

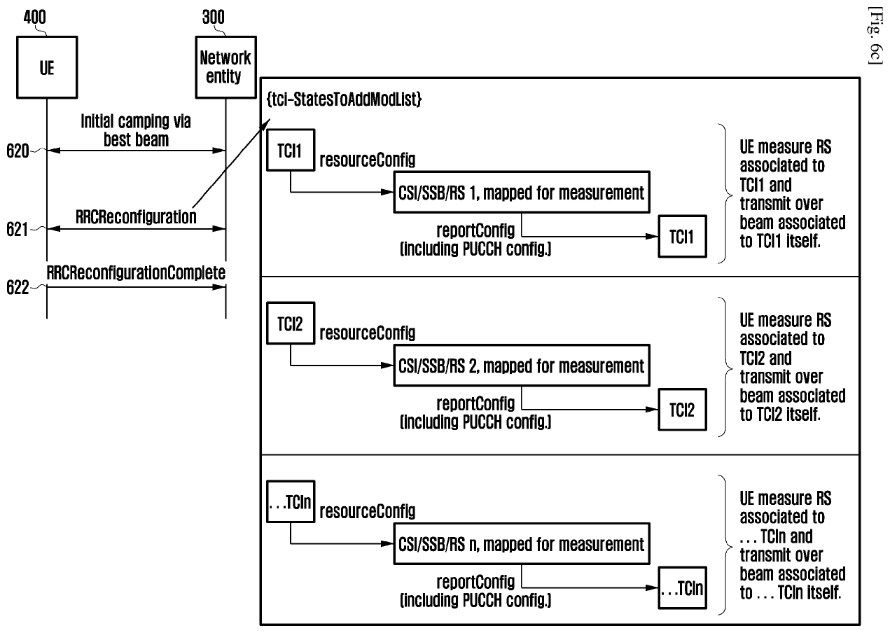

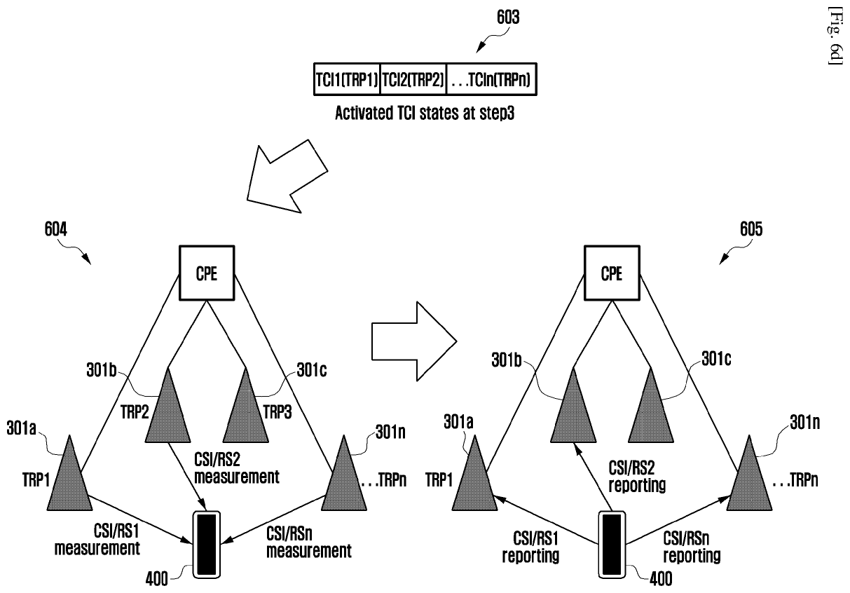

In one or more embodiments, the user centric cluster formation module 321 may receive one or more network parameters from a User Equipment (UE). The one or more network parameters comprise Channel State Information Reference Signal (CSI-RS) information, Transmission Configuration Indicator (TCI) state measurement information, Uplink (UL) pilot signal information, and location sensing information. The user centric cluster formation module 321 may further process the one or more received network parameters at the network entity comprising a centralized processing at the TRP-C and a localized processing at each TRP associated with the multiple TRPs. The user centric cluster formation module 321 may further form the UCC for the at least one CF femtocell deployment based on at least one of the centralized processing at the TRP-C and the localized processing at the multiple TRPs, as described in conjunction with FIG. 5, FIGS. 6A, 6B, 6C, and 6D, FIG. 7, FIGS. 8A and 8B, FIG. 9, and FIGS. 10A, 10B, 10C, and 10D.

In one or more embodiments, the user centric cluster formation module 321 may execute multiple operations to receive the one or more network parameters from the UE at the TRP-C, which are given below.

The user centric cluster formation module 321 may detect that the UE camped on a first TRP among the multiple TRPs, wherein the UE camped on the first TRP by utilizing a beam sweep procedure. The user centric cluster formation module 321 may further determine a presence of one or more TRPs within a coverage area of the UE by analyzing an Angle of Arrival (AoA) and an Angle of Departure (AoD) of a current serving beam used by the UE. The user centric cluster formation module 321 may further select a TCI state measurements request to the UE to determine a first list of TRPs being part of the UCC. The user centric cluster formation module 321 may further receive, upon sending the TCI state measurements request, the one or more network parameters from the UE at the TRP-C comprise the CSI-RS information, the TCI state measurement information associated with the multiple TRPs.

The user centric cluster formation module 321 may determine, upon reception of the location sensing information, a current location of the UE by using one or more mechanisms, wherein the one or more mechanisms comprises:

a. The user centric cluster formation module 321 may manage a database of serving TRPs at the TRP-C, wherein the TRP-C maintains a record of the UCC for each UE located in an indoor environment, with updates made based on a prior UCC configuration for each UE.

b. The user centric cluster formation module 321 may map the serving TRPs based on the current location of the UE, wherein the TRP-C assigns the serving TRPs as part of the UCC of the UE based on the current location of the UE.

c. The user centric cluster formation module 321 may map the serving TRPs based on the current location of the UE, wherein the TRP-C determines the current location of the UE by utilizing at least one of a communication signal reflection mechanism associated with the UE and a backscatter communication mechanism associated with the UE, and wherein the TRP-C assigns the serving TRPs as part of the UCC of the UE based on the current location of the UE.

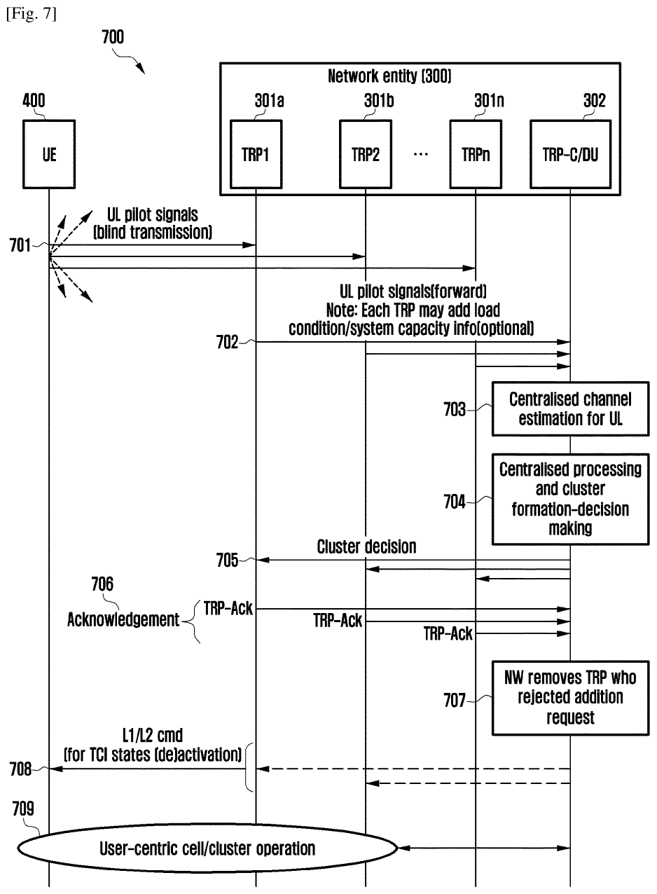

In one or more embodiments, the user centric cluster formation module 321 may execute multiple operations for centralized processing at the TRP-C, which may relate to FIG. 5 and FIG. 7, which are given below.

The user centric cluster formation module 321 may determine load condition information and capacity information of each TRP. The user centric cluster formation module 321 may determine an uplink channel condition associated with each TRP, wherein each TRP transmits an UL pilot signal received from the UE along with the determined load condition information, the determined capacity information to the TRP-C and the TRP-C estimates centralized channel for the UL pilot signal. The user centric cluster formation module 321 may determine a first list of TRPs being part of the UCC based on at least one of the determined load condition information, the determined capacity information, and the determined uplink channel condition.

In one or more embodiments, the user centric cluster formation module 321 may execute multiple operations for forming the UCC for the at least one CF femtocell deployment based on the centralized processing at the TRP-C, which may relate to FIG. 5 and FIG. 7, which are given below.

The user centric cluster formation module 321 may send a cluster decision message to each TRP associated with the first list of determined TRPs. The user centric cluster formation module 321 may further receive, upon sending the cluster decision message, an acknowledgement message from each TRP associated with the list of determined TRPs comprising a positive acknowledgement message, or a negative acknowledgement message based on the determined load condition information and the determined capacity information. The user centric cluster formation module 321 may further determine a second list of TRPs being part of the UCC, wherein the TRP-C removes one or more TRPs that send the negative acknowledgement message to the TRP-C. The user centric cluster formation module 321 may further send the determined second list of TRPs to the UE to keep active the TRPs that agreed to serve in the UCC through the positive acknowledgement message and deactivate the TRPs that do not agree to serve in the UCC through the negative acknowledgement message by managing the TCI states that are uniquely mapped to each TRP and (de)activation using a Layer 1 (L1) Downlink Control Information (DCI) command or a Layer 2 (L2) Media Access Control Element (MAC CE) command. The user centric cluster formation module 321 may further form, based on the determined second list of TRPs, the UCC for the at least one CF femtocell deployment.

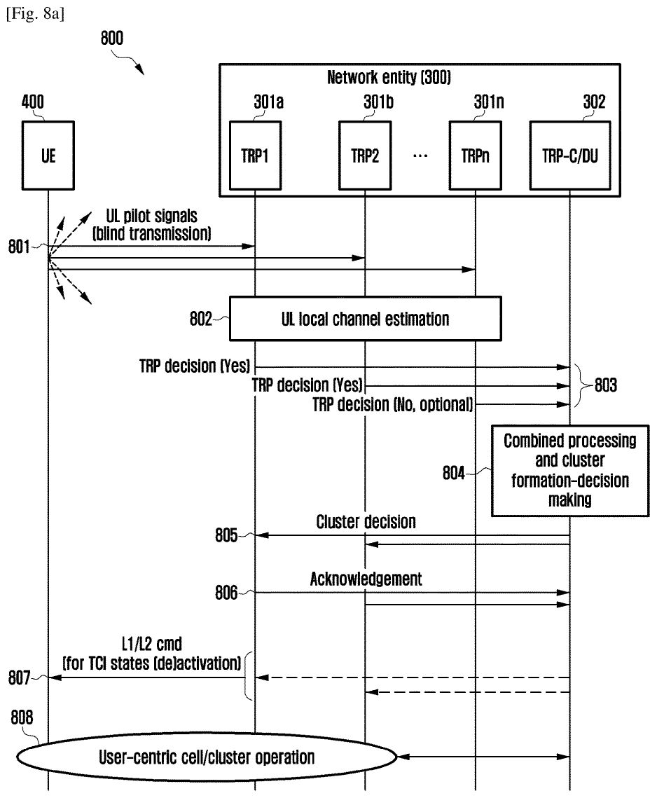

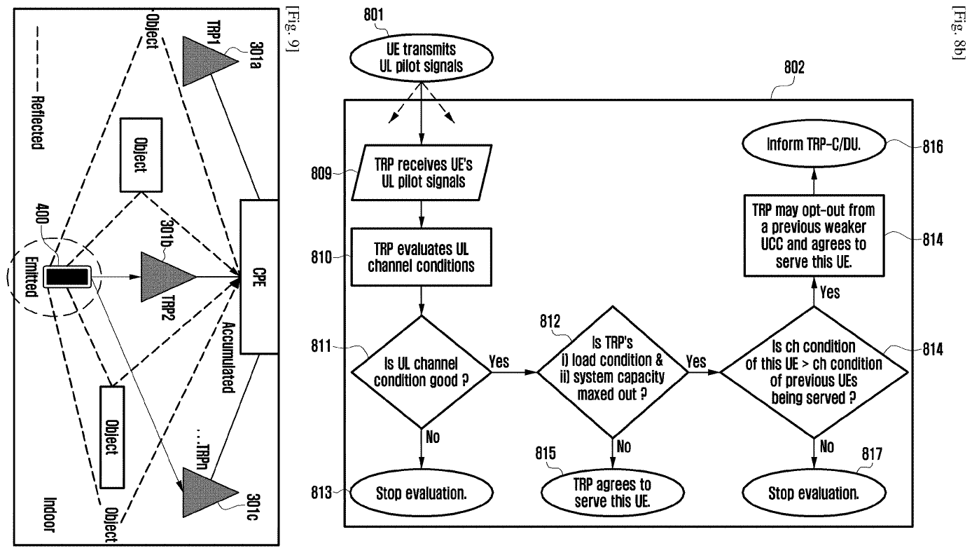

In one or more embodiments, the user centric cluster formation module 321 may execute multiple operations for localized processing at each TRP, which may relate to FIGS. 6A, 6B, 6C, and 6D, and FIGS. 8A and 8B, which are given below.

The user centric cluster formation module 321 may send a TRP decision message to the TRP-C. In one embodiment, the TRP decision message comprises one of a positive TRP decision message and a negative TRP decision message In one embodiment, the TRP decision message is determined based on at least one of a load condition information, capacity information, an Uplink (UL) channel condition and by comparing an UL channel condition of a current UE with an UL channel condition of a previously served UE. In one embodiment, the TRP-C configures a TCI state reporting framework in the UE by using a Radio Resource Control (RRC) reconfiguration message upon detecting that the UE is camped on a first TRP among the multiple TRPs.

In one or more embodiments, the user centric cluster formation module 321 may execute multiple operations for forming the UCC for the at least one CF femtocell deployment based on the localized processing at each TRP, which may relate to FIGS. 6A, 6B, 6C, and 6D, and FIGS. 8A and 8B, which are given below.

The user centric cluster formation module 321 may determine, upon reception of the TRP decision message, a list of TRPs that send the positive TRP decision message. The user centric cluster formation module 321 may further send a cluster decision message to one or more TRPs associated with the determined list of TRPs. The user centric cluster formation module 321 may further receive, upon sending the cluster decision message, an acknowledgement message from the one or more TRPs. The user centric cluster formation module 321 may further send the determined list of TRPs to the UE to keep active the TRPs that agreed to serve in the UCC through the positive acknowledgement message and deactivate the TRPs that do not agree to serve in the UCC through the negative acknowledgement message by managing the TCI states that are uniquely mapped to each TRP and (de)activation using the L1 DCI command or the L2 MAC CE command. The user centric cluster formation module 321 may further form, based on the determined list of TRPs, the UCC for the at least one CF femtocell deployment.

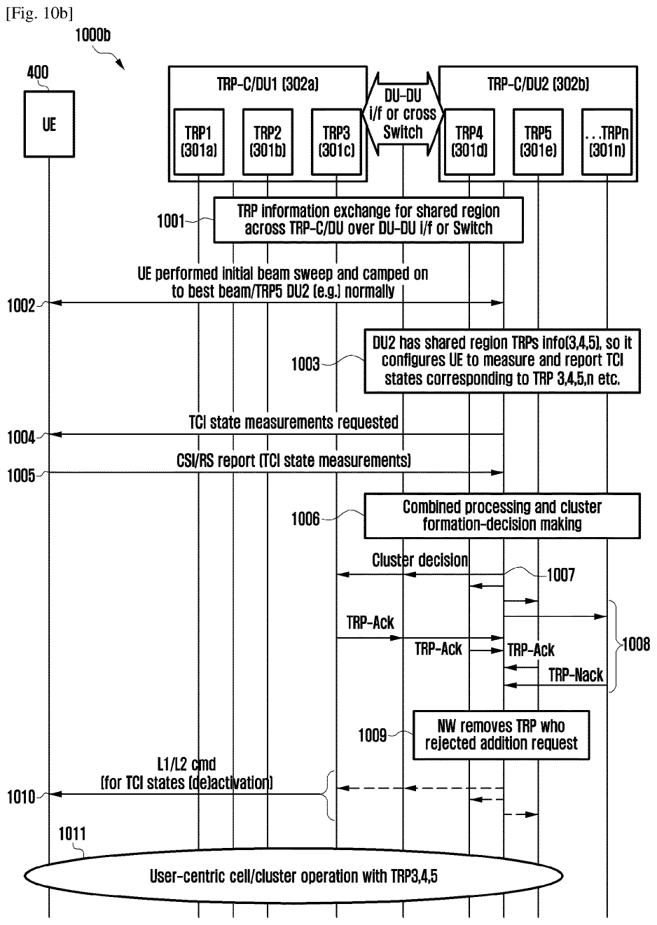

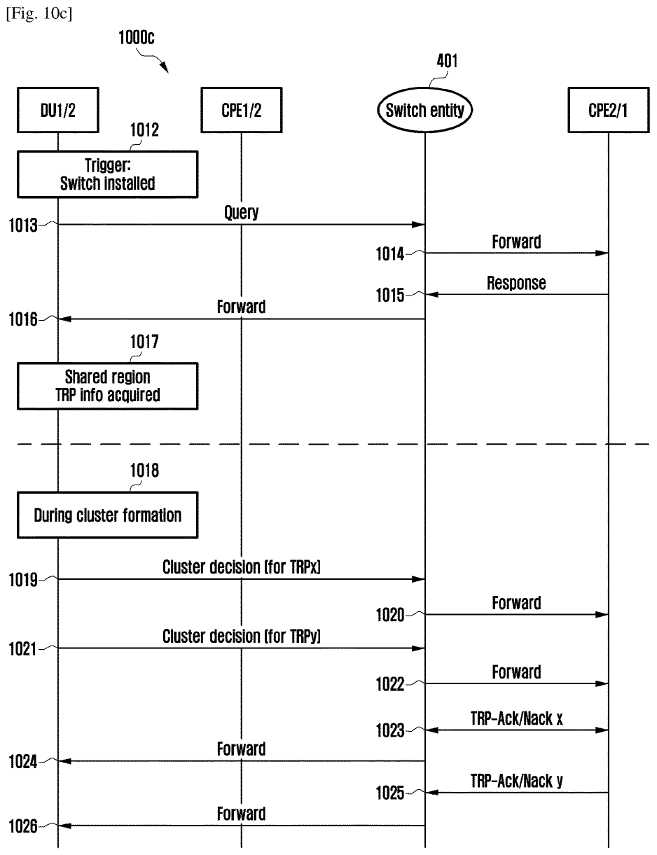

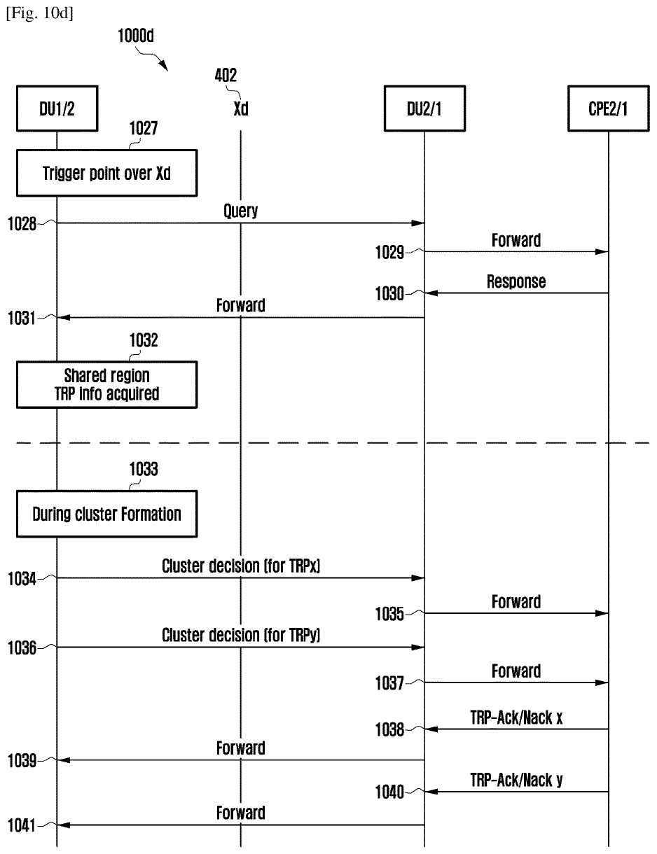

In one or more embodiments, the user centric cluster formation module 321 may exchange information between multiple TRP-Cs by using at least one of a switch entity and a DU-DU interface, wherein the information comprises a list of TRPs present in a shared region between multiple TRP-Cs. The user centric cluster formation module 321 may further form, based on the exchanged information, the UCC for the at least one CF femtocell deployment, which may relate to FIGS. 10A, 10B, 10C, and 10D.

The communicator 330 is configured for communicating internally between internal hardware components and with external devices (e.g., server) via one or more networks (e.g., radio technology). The communicator 330 includes an electronic circuit specific to a standard that enables wired or wireless communication.

Although FIG. 3 shows various hardware components of the network entity 300, but it is to be understood that other embodiments are not limited thereon. In other embodiments, the network entity 300 may include less or more number of components. Further, the labels or names of the components are used only for illustrative purposes and do not limit the scope of the invention. One or more components can be combined to perform the same or substantially similar functions to form the UCC for the at least one CF femtocell deployment.

FIGS. 4A, 4B, 4C, 4D, and 4E illustrate exemplary scenarios for designing the CF femtocell deployment, according to an embodiment as disclosed herein.

Referring to FIG. 4A: illustrates one exemplary scenario where the network entity 300 is deployed within an indoor environment. Examples of the indoor environment may include, but are not limited to, a large office building, a shopping mall, a home, etc. In this exemplary scenario, the network entity 300 has Central Unit (CU) and Distributed Unit (DU) functionality. (e.g., Customer Premise Equipment (CPE)=CU+DU). One or more Remote Units (RUs) (e.g., 301a, 301b, . . . , 301n) are strategically positioned as multiple distributed antennas or TRPs in a systematic layout to provide coverage to the UE 400 throughout the indoor environment. Further, the network entity 300 is connected to an external 6G Core Network (CN) 305 via a public infrastructure 303, wherein the public infrastructure 303 may include, for example, an internet connection, routed through a secure Gateway (GW) 304.

For instance, in the large office building, the network entity 300, equipped with CU and DU capabilities, is strategically positioned to ensure seamless connectivity for the employees' mobile devices and other wireless equipment. Multiple RUs are strategically located as distributed antennas or TRPs in the systematic layout to extend coverage and capacity within the large office building. This configuration allows for efficient signal distribution and reception, catering to the diverse connectivity needs of the building occupants. Moreover, the network entity 300 is interconnected with the external 6G CN via the public infrastructure, which may involve an internet connection routed through the secure GW. This integration enables the large office building network to seamlessly interface with the broader telecommunications infrastructure, facilitating data exchange, network management, and access to external services.

In this exemplary scenario, from the perspective of a network operator, enabling external device(s) to access the external 6G core network (CN) 305 remains a significant challenge in terms of security and authentication robustness. Therefore, implementing high-end security protocols based on Post-Quantum Cryptography (PQC) and Zero Trust Architecture (ZTA) over the secured GW 304 may be beneficial for ensuring the ultra-security of such architectural designs.

Referring to FIG. 4B: illustrates one exemplary scenario where the network entity 300 is deployed within an indoor environment. In this exemplary scenario, the network entity 300 has the DU functionality. (e.g., CPE=DU). The one or more RUs (e.g., 301a, 301b, . . . , 301n) are strategically positioned as multiple distributed antennas or TRPs in a systematic layout to provide coverage to the UE 400 throughout the indoor environment. Further, the network entity 300 is linked to a distant CU 306 from a macrocell via an F1 interface.

For instance, in a large corporate office building, the network entity 300, equipped with DU functionality, is deployed to provide comprehensive wireless coverage and capacity for employees and visitors throughout the multi-story facility. The building's indoor environment presents challenges such as high user density, varying user mobility, and the need for seamless connectivity across different office areas, meeting rooms, and common spaces. The network entity 300 is strategically positioned within the building, featuring DU functionality to efficiently manage and distribute wireless signals within the indoor environment. The Multiple RUs are strategically installed as distributed antennas or TRPs in a systematic layout. For example, RUs are placed on each floor and in common areas to ensure uniform coverage and capacity. In addition, the network entity 300 is linked to the distant CU from the macrocell via the F1 interface, allowing seamless integration and coordination with the broader macrocell infrastructure.

Referring to FIG. 4C: illustrates one exemplary scenario where the network entity 300 is deployed within the indoor environment. In this exemplary scenario, the network entity 300 has TRP controller (TRP-C) functionality (e.g., CPE=TRP-C (intraDU)). The one or more RUs (e.g., 301a, 301b, . . . , 301n) are strategically positioned as multiple distributed antennas or TRPs in a systematic layout to provide coverage to the UE 400 throughout the indoor environment. Further, the network entity 300 is linked to a distant DU 307 from the macrocell via the fronthaul link. The fronthaul link is capable of being either a wired or wireless connection (e.g., a hybrid Multiple-Input Multiple-Output (MIMO) beam-based link between macrocell DU and indoor 6G CPE) between the distant DU 307 of the macrocell and the deployed network entity 300.

Referring to FIG. 4D: illustrates one exemplary scenario where the network entity 300 is deployed within a large indoor environment. In this exemplary scenario, the network entity 300 has TRP-C functionality (e.g., CPE=TRP-C (interDU)), 302 a and 302b. The one or more RUs (e.g., 301a, 301b, 301c, 301d, 301e, . . . , 301n) are strategically positioned as multiple distributed antennas or TRPs in a systematic layout to provide coverage to the UE 400 throughout the large indoor environment. Further, the network entity 300 is linked to a distant DU 307 from the macrocell via the fronthaul link. The fronthaul link is capable of being either a wired or wireless connection (e.g., a hybrid Multiple-Input Multiple-Output (MIMO) beam-based link between macrocell DU and indoor 6G CPE) between the distant DU 307a/307b of the macrocell and the deployed network entity 300. In addition, a switch entity 401 is deployed between the one or more deployed network entities to exchange information between multiple TRP-Cs, 302 a and 302b, to form the UCC, wherein the information comprises a list of TRPs present in a shared region between multiple TRP-Cs, 302 a and 302b.

In other words, the exemplary scenario is better suited for large indoor environments, such as malls or stadiums, where each CPE (e.g., 302 a and 302b) can be linked with a different macrocell DU. Each CPE (e.g., 302 a and 302b) primarily consists of the TRP-C role with its RUs positioned as multiple distributed antennas or TRPs in a planned arrangement to cover a section of the indoor environment. Each CPE (e.g., 302 a and 302b) is connected to a separately located 6G DU (e.g., DU1 307a and DU2 307b) via the fronthaul link, which can be either wired or wireless. For the purposes of cross-TRP clustering, coordination, and resource scheduling, it is crucial to have a cross-CPE-DU to CPE-DU communication link, such as an external switch (i.e., switch entity 401). The switch can be a user-deployed entity positioned outside or on top of a large indoor environment, and the switch can be connected to outside serving DUs via a wired or wireless (hybrid MIMO beam) link, as well as to inside CPEs via a wired link. Alternatively, the purpose can be achieved by a standard DU-DU interface (e.g., Xd, as illustrated in FIG. 4E); however, for cross-CPE scheduling, a cross-switch may serve as a faster option with reduced latency. For communication across CPE-DU1< >CPE-DU2, the switch may have at least the following forwarding functionalities, for example:
1) Shared region TRP/TCI state information sharing;
2) Cross interface TRP cluster configuration and feedback; and
3) Cross interface TRP scheduling via a master DU.

Referring to FIG. 4E: illustrates one exemplary scenario where the network entity 300 is deployed within a large indoor environment. In this exemplary scenario, the network entity 300 has TRP-C functionality (e.g., CPE=TRP-C (interDU)), 302 a and 302b. The one or more RUs (e.g., 301a, 301b, 301c, 301d, 301e, . . . , 301n) are strategically positioned as multiple distributed antennas or TRPs in a systematic layout to provide coverage to the UE 400 throughout the large indoor environment. Further, the network entity 300 is linked to a distant DU 307 from the macrocell via the fronthaul link. The fronthaul link is capable of being either a wired or wireless connection (e.g., a hybrid Multiple-Input Multiple-Output (MIMO) beam-based link between macrocell DU and indoor 6G CPE) between the distant DU 307a/307b of the macrocell and the deployed network entity 300. In addition, a DU-DU interface is deployed between the one or more deployed network entities to exchange information between multiple TRP-Cs, 302 a and 302b, to form the UCC, wherein the information comprises the list of TRPs present in the shared region between multiple TRP-Cs, 302 a and 302b.

In other words, the exemplary scenario is better suited for large indoor environments, such as malls or stadiums, where each CPE (e.g., 302 a and 302b) can be linked with a different macrocell DU. Each CPE (e.g., 302 a and 302b) primarily consists of the TRP-C role with its RUs positioned as multiple distributed antennas or TRPs in a planned arrangement to cover a section of the indoor environment. Each CPE (e.g., 302 a and 302b) is connected to a separately located 6G DU (e.g., DU1 307a and DU2 307b) via the fronthaul link, which can be either wired or wireless. For the purposes of cross-TRP clustering, coordination, and resource scheduling, it is crucial to have the cross-CPE-DU to CPE-DU communication link, such as the DU-DU interface (Xd). For communication across CPE-DU1< >CPE-DU2, the switch may have at least the following forwarding functionalities, for example:
1) Shared region TRP/TCI state information sharing;
2) Cross interface TRP cluster configuration and feedback; and
3) Cross interface TRP scheduling via the master DU.

In one or more embodiments, the aforementioned options (FIGS. 4A, 4B, 4C, 4D, and 4E), in general, the functionality of the CPE 302 may encompass additional roles similar to the TRP-C, including:
1) Centralized channel estimation and processing;
2) Centralized uplink (UL) feedback processing;
3) Formation, decision-making, and management of TRP clusters;
4) Dynamic cluster updates through TRP activation/deactivation and communication of the same to the UE 400 via Transmission Configuration Information (TCI) states, uniquely mapped to TRPs, using L1/L2 MAC-CE commands; and
5) Management of indoor cluster databases, user location sensing (utilizing communication signal reflections), and tracking for efficient cluster formation.

FIG. 5 is a sequence flow diagram illustrating a method 500 for forming the UCC for the CF femtocell deployment based on the centralized processing at the TRP-C 302, according to an embodiment as disclosed herein. The sequence flow diagrams include several operations outlined as follows.

In the initial operation 501, when the UE 400 is already connected to an optimal primary beam of a primary Distributed Unit (DU) (i.e., TRP-C/DU 302) through a known beam sweep procedure such as the NR mmW system, there are two potential approaches for the network entity 300 to configure multiple TRPs (e.g., TRP1 301a, TRP2 301b, . . . , TRPn 301n), or said the first list of TRPs being part of the UCC, in order to establish the UCC.

In the subsequent operation 502, leveraging the AoA, the AoD, and (quasi)colocation information of the UE's current serving beam, the TRP-C/DU 302 may determine which other TRP(s) (e.g., TRP1 301a, TRP2 301b, . . . , TRPn 301n) are currently present in the UE's serving vicinity. Subsequently, two types of the UCC may be established:

1) The TRP-C/DU 302 may select a static UCC from the identified TRP(s) and directly activate the uniquely mapped Transmission Channel Information (TCI) states by transmitting the L1 DCI or the L2 MAC-CE command to the UE 400, thereby forming a static cluster.

2) Alternatively, in operations 503 and 504, the TRP-C/DU 302 may configure measurement and reporting for the TCI states (uniquely mapped to TRPs) and, based on the UE's CSI/RS report, determine which TRPs will be part of the UCC, thereby forming a dynamic cluster.

In operation 505, the TRP-C/DU 302 may make the decision to form the UCC and determine which TRPs (e.g., TRP1 301a, TRP2 301b, . . . , TRPn 301n) to include. Additionally, the TRP-C/DU 302 may take into account the load condition (i.e., load condition information) and system capacity (i.e., capacity information) of each TRP when making this decision. In operation 506, the TRP-C/DU 302 (cluster manager entity), may notify all selected candidate TRPs (e.g., TRP1 301a, TRP2 301b, . . . , TRPn 301n), which will be coordinating as part of the UCC, about the cluster decision. Upon receiving the cluster decision in operation 507, each TRP (e.g., TRP1 301a, TRP2 301b, . . . , TRPn 301n) may respond with an TRP acknowledgment (TRP-Ack) or TRP negative acknowledgment (TRP-Nack) message. Each TRP (e.g., TRP1 301a, TRP2 301b, . . . , TRPn 301n) may decide to reject/Nack the request based on its load conditions or system capacity.

If the TRP-C/DU 302 receives the TRP-Nack from any TRP (e.g., TRPn 301n) in operation 508, the TRP-C/DU 302 may subsequently remove that TRP (e.g., TRPn 301n) from the established UCC. In order to optimize transmissions and receptions, the TRP-C/DU 302 may inform the UE 400 about which TRPs belonging to the UCC (e.g., TRP1 301a, TRP2 301b), or said second list of TRPs being part of the UCC, to keep active by managing TCI states (uniquely mapped to each TRP) through (de)activation using L1 (DCI) or L2 (MAC CE) commands in operation 509. Finally, in operation 510, the UE 400 may operate in Downlink (DL)/Uplink (UL) using the activated TCI states (uniquely mapped to each TRP) as part of the UCC. Further, it's important to note that the (de)activation procedure for TCI states can utilize the same MAC CE format as currently defined for NR systems (reference: 3GPP TS 38.321, section 6.1.3.47).

FIGS. 6A, 6B, 6C, and 6D illustrate one or more operations associated with a method for forming the UCC for the CF femtocell deployment based on the localized processing 600 at each TRP associated with the multiple TRPs, according to an embodiment as disclosed herein.

Referring to FIG. 6A: in the initial operation 601, when the UE 400 is already connected to an optimal primary beam of a primary Distributed Unit (DU) (i.e., TRP-C/DU 302) through a known beam sweep procedure such as the NR mmW system. In the subsequent operation 602, leveraging the AoA, the AoD, and (quasi)colocation information of the UE's current serving beam, the TRP-C/DU 302 may determine which other TRP(s) (e.g., TRP1 301a, TRP2 301b, . . . , TRPn 301n) are currently present in the UE's serving vicinity, or said first list of TRPs being part of the UCC.

In operation 603, the TRP-C/DU 302 may first activate all detected candidate TCI states, uniquely mapped to TRPs, via the L1 DCI or the L2 MAC-CE commands to the UE 400, as illustrated in FIG. 6D. In operation 604, subsequently, the TRP-C/DU 302 may configure CSI/RS measurement and reporting for those TCI states. Referring to FIG. 6D, the reporting configuration (“reportConfig”) of each TCI state to be measured will be set up in a manner where, instead of the UE 400 sending all RS measurements over the primary TRP to the DU, the UE 400 may send each CSI/RS measurement over its corresponding TRP (TCI state) itself, as depicted in operation 605. This proposed reporting configuration will be configured by the TRP-C/DU 302 to the UE 400 in the Radio Resource Control (RRC) Reconfiguration message after the initial camping (at 601/620/621/622), as shown in FIG. 6C.

In operation 606, with the aforementioned approach, as each TRP (e.g., TRP1 301a, TRP2 301b, . . . , TRPn 301n) may receive its corresponding CSI/RS measurement, the decision to serve the UE 400 and thus be part of the UCC can be made locally at each TRP (e.g., TRP1 301a, TRP2 301b, . . . , TRPn 301n) for expedited processing, which have advantageous over conventional systems. In operation 607, each TRP (e.g., TRP1 301a, TRP2 301b, . . . , TRPn 301n) receiving its CSI/RS measurement will process it locally for accelerated processing and relay their decision (e.g., TRP decision (yes), TRP decision (no, optional), etc.) to serve this UE 400 or not (taking into account each TRP's load condition and system capacity) to the TRP-C/DU 302 (cluster manager entity such as TRP-C or DU).

In operations 608-609, the TRP-C/DU 302 may inform all the selected candidate TRPs (e.g., TRP1 301a, TRP2 301b, . . . , TRPn 301n) (those that will be coordinating as part of the UCC) by sending the cluster decision message and dynamically manage the formed UCC. In addition, the TRP-C/DU 302 may receive acknowledgement in response to sending the cluster decision message from the selected candidate TRPs (e.g., TRP1 301a, TRP2 301b, . . . , TRPn 301n).

In operations 610-611, to optimize transmissions and receptions, the TRP-C/DU 302 may inform the UE 400 about which TRPs belong to the UCC (e.g., TRP1 301a, TRP2 301b) to keep active by managing TCI states (uniquely mapped to each TRP) through (de)activation using the L1 (DCI) or L2 (MAC CE) commands. Consequently, the UE 400 may operate in the DL/UL using the activated TCI states (uniquely mapped to each TRP) as part of the UCC.

Referring to FIG. 6B: illustrates a flowchart detailing the process by which each TRP (e.g., TRP1 301a, TRP2 301b, . . . , TRPn 301n) may handle its individual CSI/RS measurement as received in operation 606. In operation 605, the UE 400 may transmit the CSI/RS measurement (e.g., over the configured Physical Uplink Control Channel (PUCCH)) of the TCI state over its corresponding TRP. In operations 612-613, the corresponding TRP receives and processes this report. In operation 614, each TRP (e.g., TRP1 301a, TRP2 301b, . . . , TRPn 301n) checks the condition to determine whether its load condition or system capacity is at maximum capacity. In operation 615, if the condition is “no”, then the TRP (e.g., TRP1 301a, TRP2 301b) agrees to serve this user (i.e., UE 400) as part of its UCC. In operation 616, if the condition is “yes”, then the TRP further checks if the Uplink (UL) link condition of the UE 400 is better than the UL link of UE(s) (e.g., UE 400X (not shown in FIG.)) that are already being served by the TRP. In operation 617, if the condition is “no”, then the TRP stops processing the report. In operation 618, if the condition is “yes”, then the TRP may decide to opt out from serving a weaker previous UE (e.g., UE 400X (not shown in FIG.)) and agree to serve the current UE (i.e., UE 400) instead. In operation 619, the TRP informs its decision to the TRP-C/DU 302.

FIG. 7 is a sequence flow diagram illustrating a method 700 for forming the UCC for the CF femtocell deployment based on the centralized processing at the TRP-C and Uplink (UL) pilot signal information, according to an embodiment as disclosed herein. The sequence flow diagrams include several operations outlined as follows.

In the initial operation 701, the UE 400 may transmit its Uplink (UL) orthogonal pilot signals (i.e., UL pilot signal information) on all its Transmission (Tx) beams and anticipate that certain TRPs may receive these signals. In the subsequent operation 702, all TRPs (e.g., TRP1 301a, TRP2 301b, . . . , TRPn 301n), or said first list of TRPs, receiving the UE's UL signals may relay the signals to be centrally processed through the TRP-C/DU 302 (cluster manager entity), aiming to achieve improved spectral efficiency. Subsequently, in operations 703, 704, and 705, the TRP-C/DU 302 may centrally evaluate the channel condition and make a decision regarding which TRPs will serve the UE 400, taking into account each TRP's load condition and system capacity. The TRP-C/DU 302 may send the cluster decision to each TRP (e.g., TRP1 301a, TRP2 301b, . . . , TRPn 301n) associated with the first list of determined TRPs.

In operation 706, each TRP (e.g., TRP1 301a, TRP2 301b, . . . , TRPn 301n) may respond with a positive acknowledgment (TRP-Ack) or negative acknowledgment (TRP-Nack) message. Consequently, in operation 707, the TRP-C/DU 302 may remove or add TRP based on the acknowledgement (e.g., add: TRP1 301a, TRP2 301b). In operation 708, in order to optimize transmissions and receptions, the TRP-C/DU 302 may inform the UE 400 about which TRPs belonging to the UCC, or said second list of TRPs being part of the UCC, to keep active by managing TCI states (uniquely mapped to each TRP) through activation or deactivation using the L1 DCI or L2 MAC-CE commands. Finally, in operation 709, the UE 400 may operate in the DL/the UL using the activated TCI states (uniquely mapped to each TRP) as part of the UCC.

FIGS. 8A and 8B illustrate one or more operations associated with a method 800 for forming the UCC for the CF femtocell deployment based on the localized processing at each TRP associated with the multiple TRPs and the UL pilot signal information, according to an embodiment as disclosed herein.

Referring to FIG. 8A: in the initial operation 801, the UE 400 may transmit its UL orthogonal pilot signals on all its Transmission (Tx) beams and anticipate that certain TRPs may receive these signals. In the subsequent operations 802-803, all TRPs (e.g., TRP1 301a, TRP2 301b, . . . , TRPn 301n), or said first list of TRPs, receiving the UE's UL signals may access the channel conditions locally (for faster processing, 803) and forward corresponding TRP decision (e.g., TRP decision (Yes), TRP decision (No, optional), etc.) to serve the UE 400 or not (may also consider each TRP's load condition and system capacity) to the TRP-C/DU 302. In operation 804, the TRP-C/DU 302 may combine processing and make the cluster decision based on the received corresponding TRP decision from each TRP (e.g., TRP1 301a, TRP2 301b, . . . , TRPn 301n).

In operation 805, the TRP-C/DU 302 may send the cluster decision to the TRP (e.g., TRP1 301a, TRP2 301b) which sends the response as “TRP decision (Yes)”. In operation 806, the TRP (e.g., TRP1 301a, TRP2 301b) sends the acknowledgment to the TRP-C/DU 302 upon receiving the cluster decision. In operation 807, in order to optimize transmissions and receptions, the TRP-C/DU 302 may inform the UE 400 about which TRPs belonging to the UCC to keep active by managing TCT states (uniquely mapped to each TRP) through activation or deactivation using the L1 DCI or L2 MAC-CE commands. Finally, in operation 808, the UE 400 may operate in the DL/the UL using the activated TCI states (uniquely mapped to each TRP) as part of the UCC.

Referring to FIG. 8B: the flowchart illustrates the process 802 by which each TRP may handle the UE′ UL pilot signal. In operation 801, the UE 400 transmits the UL pilot signal on all its Transmission (Tx) beams. In operations 809-810, a receiving TRP captures the pilot signal and locally assesses the UL channel conditions. In operation 811, each TRP (e.g., TRP1 301a, TRP2 301b, . . . , TRPn 301n) evaluates whether the assessed UL channel condition is satisfactory. If the condition is “no”, then at operation 813, the TRP ceases processing the pilot signal. If the condition is “yes”, then at operation 812, each TRP (e.g., TRP1 301a, TRP2 301b, . . . , TRPn 301n) checks whether its load condition or system capacity is at maximum capacity. If the condition is “no”, then at operation 815: the TRP (e.g., TRP1 301a, TRP2 301b) agrees to serve this user (i.e., UE 400) as part of its UCC. If the condition is “yes”, then at operation 814, the TRP further compares the channel condition of the UE 400 with the channel condition of other UE(s) (e.g., UE 400X (not shown in FIG.)) that are already being served by this TRP. If the condition is “no”, then at operation 817, the TRP (e.g., TRPn 301n) stops processing. If the condition is “yes”, then at operation 816, the TRP (e.g., TRP1 301a, TRP2 301b) may decide to opt-out from serving a weaker previous UE (e.g., UE 400X (not shown in FIG.)) and agree to serve the current UE (i.e., UE 400) instead. In operation 818, each TRP (e.g., TRP1 301a, TRP2 301b, . . . , TRPn 301n) communicates its decision to the TRP-C/DU 302.

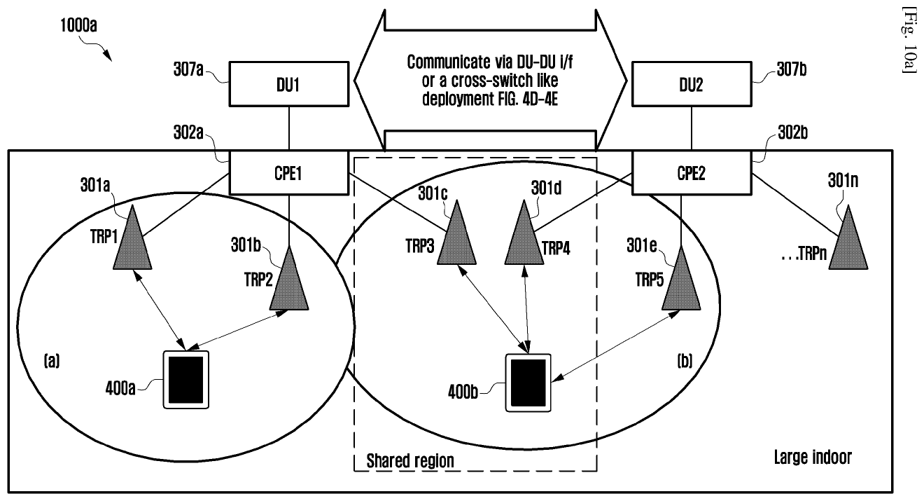

FIG. 9 illustrates one or more operations associated with a method for forming the UCC for the CF femtocell deployment based on location sensing information, according to an embodiment as disclosed herein.

In a femtocell indoor environment, a process of learning, sensing, and identifying a user's precise location (i.e., UE 400) within a specific area of the indoor facility becomes more streamlined over time by employing various advanced techniques, including:

1) Management of the serving TRP set database at the cluster manager entity (CPE or TRP-C/DU 302), where the TRP-C/DU 302 maintains a comprehensive database of the UCC comprising the TRPs (e.g., TRP1 301a, TRP2 301b, . . . , TRPn 301n) involved for each user indoors. This database is continuously updated based on past UCC configurations for the respective UE 400.

2) Mapping of the serving TRP set based on the UE's geographical coordinates (latitude, longitude), where the TRP-C/DU 302 maps the serving TRPs (part of the UE's UCC) according to the UE's precise location information (i.e., location sensing information).

3) Mapping of the serving TRP set based on the UE's location sensing techniques, such as utilizing communication signal reflections or employing innovative methods like backscatter communication technology. In this approach, the TRP-C/DU 302 maps the serving TRPs (part of the UE's UCC) based on the UE's location sensing capabilities, leveraging communication signal reflections indoors or utilizing backscatter communication technology.

By leveraging any of the aforementioned UE location identification techniques, the Network (NW) (e.g., TRP-C/DU 302) can configure the serving UCC of TRPs and activate them using the L1 DCI or the L2 MAC-CE commands to enable the activation of the corresponding TCI states, uniquely mapped to specific TRPs, for transmission and reception purposes.

FIGS. 10A, 10B, 10C, and 10D illustrate one or more operations associated with a method for forming the UCC with multiple TRPs connected across multiple Distributed Units (DUs), according to an embodiment as disclosed herein.

Referring to FIG. 10A: in large indoor environments 1000a such as malls or stadiums, it is conceivable that certain CPEs (e.g., 302a and 302b) within the 6G femtocell infrastructure are interconnected across diverse DUs (e.g., DU1 307a and DU2 307b). Consequently, two distinct classifications of UCCs may emerge: a grouping in which all TRPs (e.g., TRP1 301a, TRP2 301b, . . . , TRPn 301n) are managed by a singular CPE-DU, and a grouping in which certain TRPs (e.g., TRP1 301a, TRP2 301b) fall under the jurisdiction of one CPE-DU while the remainder (e.g., TRP3 301c, TRP4 301d, TRP5 301e) are overseen by another CPE-DU. In this context, from the standpoint of the UE (e.g., 400a and 400b), it is imperative for the UE (e.g., 400a and 400b) to recognize the cell/UCC as a sole Physical Cell Identity (PCI) under a designated DU (referred to as the master DU) exclusively. The UE (e.g., 400a and 400b) may not be preoccupied with the specifics of which TRP is linked to which CPE-DU, as this information is intended to remain inconspicuous and immaterial to the UE (e.g., 400a and 400b). For instance, in FIG. 10A, UE1 400a is situated in UCC (a) and is served by the TRP1 301a and TRP2 301b under the control of master CPE1-DU1 (302a and 307a), while UE2 400b is located in UCC (b) and is serviced by the TRP3 301c, TRP4 301d, and TRP5 301e under the governance of master CPE2-DU2 (302b and 307b).

Referring to FIG. 10B: cluster formation include several operations 1000b outlined as follows. In the initial operation 1001, it is essential to facilitate information exchange between TRP-C Dus (e.g., 302a and 302b), involving data pertaining to TRPs located within shared regions across multiple TRP-C/DUs. For instance, as depicted in FIG. 10A, TRP3 301c and TRP4 301d are situated within a shared region. This exchange can occur through the switch entity (architecture FIG. 4D) or the new standard DU-DU interface (architecture FIG. 4E). The specific message sequences for the proposed information exchange across the interfaces are detailed in a subsequent section with reference to FIG. 10C and FIG. 10D. Subsequently, in operation 1002, the UE 400 performs an initial beam sweep and establishes a connection with the most optimal primary beam/DU, akin to the standard procedure in a typical NR mmWave system, from among the multiple DUs present. The selected DU, where the UE 400 is camped, is henceforth referred to as the masterDU (e.g., TRP-C/DU2 302b).

In operations 1003-1004, the NW (masterDU) identifies the UE's proximity based on the current best serving beam and the UE's location estimation technique(s). The masterDU configures the UE 400 with multiple TCI state measurements and reporting, encompassing the TCIs for TRPs situated within the shared region under the control of other CPE-DUs and are common to the UE's vicinity. The information regarding the shared region TRPs was exchanged as part of 1001.

In operations 1005-1006, the UE 400 is unaware of other CPE-DUs, conducts normal L1 and L2 based measurement and reporting for all TCI states as configured by the NW (masterDU). Subsequently, upon receiving measurements of all TCI states uniquely mapped to TRPs, the master TRP-C/DU makes decisions regarding which TRPs will constitute the user-centric cell/cluster during 1006. In operation 1007, the masterDU communicates the cluster decision to all TRPs, including those within the shared region, across the switch or DU-DU interface. Upon reception of the cluster decision, each TRP (e.g., TRP3 301c, TRP4 301d, etc.) responds with the Ack or Nack in response to the cluster decision message during operation 1008. The TRP (e.g., TRPn 301n) may decide to reject/Nack the request based on its load conditions or system capacity, and in such cases, the cluster manager entity (e.g., TRP-C/DU2 302b) removes the TRP from the formed user-centric cell/cluster during operation 1009.

To optimize transmissions and receptions, the TRP-C/DU2 302b may inform the UE 400 about which TRPs, belonging to the UCC, should remain active by managing TCI states (uniquely mapped to each TRP) through (de)activation using Layer 1 (DCI) or Layer 2 (MAC CE) commands during operation 1010. Consequently, the UE 400 operates in Downlink/Uplink using the activated TCI states uniquely mapped to each TRP as part of the UCC during operation 1011. In addition, the functionality of information exchange and cluster decision making, including TRPs across shared regions, can also be divided between the DU and TRP-C, or entirely delegated to the master TRP-C itself if it has a link to other TRP-C via the switch.

Referring to FIG. 10C: illustrating the message sequence flow 1000c for information exchange, in operation 1012, encompassing TRPs located within the shared region between two CPE1-DU1< >CPE2-DU2, across the switch entity 401 involves the following operations.

During operation 1013, the masterDU transmits a query message, containing the forwarding address (e.g., to the other CPE), to the switch entity 401. Subsequently, in operation 1014, the switch entity 401 forwards the query message to the intended other CPE entity. In operation 1015, the queried CPE responds with a response message, including the forwarding address (e.g., to the masterDU) and shared region TRP(s) information. Message design for the query message and the response message are illustrated, for example, in Table-1.

Following this, in operation 1016, the switch entity 401 forwards the response message to the intended masterDU. As a result, in operation 1017, the masterDU obtains the TRP(s) information pertaining to the shared region between CPE1-DU1 and CPE2-DU2, connected across the switch entity 401. Subsequently, during operation 1018, the masterDU, armed with all TRP(s) information, proceeds with the actual UCC formation, making decisions regarding cluster formation. In operations 1019,1020, 1021, and 1022, the masterDU dispatches the cluster decision (to each TRP which is part of the UCC) via the switch entity 401, including the forwarding address. The switch entity 401 then forwards the cluster decision message to the intended other CPE entity for each TRP. In operations 1023,1024, 1025, and 1026, upon receiving the cluster decision, each TRP responds with an Acknowledgement (TRP_Ack/Nack) via the CPE over the switch entity 401 to the masterDU (final end point). In the event of a Nack from any TRP, the masterDU updates the UCC by excluding such TRP.

TABLE 1

| | |
|---|---|
| Query message | Purpose: masterDU posts Query to get shared region TRP |
| design over | information (under control of other/cross-connected CPE/TRP-C) |
| switch entity 401 | Direction: masterDU -> cross-connected CPE/TRP-C |
| | Interface: FAPI/nFAPI (forwarding over Switch) |
| | Message Name: SharedTRP_Query |
| | Structure: {regionInfo: <coordinates/dimensions> //A set of |
| | values to identify the shared region between two CPEs/TRP- |
| | Cs/DUs} |
| | Note: Query message shall include a header with destination |
| | entity's address/forwarding address. |
| Response | Purpose: It is a Response to masterDU's Query message wherein |
| message design | queried CPE/TRP-C replies with TRP(s) information falling in the |
| over switch entity | shared region under this CPE/TRP-C |
| 401 | Direction: cross-connected CPE/TRP-C -> masterDU |
| | Interface: FAPI/nFAPI (forwarding over Switch) |
| | Message Name: Shared_TRP_Response |
| | Structure: {TRPCount: <Integer> //Count of total number of |
| | TRPs information included |
| | {TRPInfo: <TCI state info> //contains TCI state info uniquely mapped to |
| | each TRP. In case it matches with a masterDU's TRP's TCI state, |
| | masterDU can assign an internal ID to distinguish while making |
| | measurement requests to UE.} . . . //till TRPCount} |
| | Note: Response message shall include a header with destination |
| | entity's address/forwarding address. |

Referring to FIG. 10D: illustrating the message sequence flow 1000d for information exchange, in operation 1027, encompassing TRPs situated within the shared region between two CPE1-DU1< >CPE2-DU2, across the Xd interface 402 involves the following operations.

In operation 1028, the masterDU transmits a query message, containing the forwarding address (e.g., to the other DU), over the Xd interface 402. Subsequently, in operation 1029, the other DU forwards the query message to the intended other CPE entity. In operation 1030, the queried CPE responds with a Response message, including the forwarding address (e.g., to the masterDU) and shared region TRP(s) information. Following this, in operation 1031, the other DU forwards the Response message to the intended masterDU over the Xd interface 402. Message design for the query message and the response message are illustrated, for example, in Table-2.

As a result, in operation 1032, the masterDU obtains the TRP(s) information pertaining to the shared region between CPE1-DU1 and CPE2-DU2, connected across the Xd interface 402. Subsequently, during operation 1033, the masterDU, armed with all TRP(s) information, proceeds with the actual UCC formation, making decisions regarding cluster formation. In operations 1034, 1035, 1036, and 1037, the masterDU dispatches the cluster decision (to each TRP which is part of the UCC) via the Xd interface 402, including the forwarding address. The other DU then forwards the Cluster decision message to the intended other CPE entity for each TRP. In operations 1038, 1039, 1040, and 1041, upon receiving the cluster decision, each TRP responds with an Acknowledgement (TRP_Ack/Nack) via the CPE over the Xd interface 402 to the masterDU (final end point). In the event of a Nack from any TRP, the masterDU updates the UCC by excluding such TRP.

TABLE 2

| | |
|---|---|
| Query message | Purpose: masterDU queries shared region TRP info under control |
| design over Xd | of other/cross-connected CPE/TRP-C |
| i/f | Direction: masterDU -> cross-connected CPE/TRP-C over Xd i/f |
| | Interface: Xd (using new DU-DU i/f forwarding function) |
| | Message Name: Shared_TRP_Query |
| | Structure: {regionInfo: <coordinates/dimensions> //A set of values |
| | to identify the shared region between two CPEs/TRP-Cs/Dus} |
| | Note: Query message shall include a header with destination |
| | entity's address/forwarding address. |
| Response | Purpose: CPE/TRP-C replies with TRP info falling in shared region |
| message design | under this CPE/TRP-C |
| over Xd i/f | Direction: cross-connected CPE/TRP-C -> DU over Xd i/f |
| | Interface: Xd (using new DU-DU i/f forwarding function) |
| | Message Name: Shared_TRP_Response |
| | Structure: {TRPCount: <Integer> //Count of total number of TRPs |
| | info included |
| | {TRPInfo: <TCI state info> //contains TCI state info uniquely mapped to |
| | each TRP. In case it matches with a masterDU's TRP's TCI state, |
| | masterDU can assign an internal ID to distinguish while measurement |
| | requests to UE.} . . . //till TRPCount} |
| | Note: Query message shall include a header with destination |
| | entity's address/forwarding address. |

In one or more embodiments, for all the cluster formation options proposed, aforementioned embodiments, there is a need to define the design of three important messages are illustrated, for example, in Table-3.

TABLE 3

| | |
|---|---|
| TRP Decision | • Purpose: To inform TRP-C/DU about TRP's decision to serve a |
| | user or not as part of its cluster in localized processing scenarios. |
| | • Direction: TRP (from each cluster candidate TRP) −> TRP-C/DU |
| | • Interface: FAPI / nFAPI |
| | • Message Name: TRP_Decision_Info |
| | • Structure: |
| | { |
| | userId: <Integer> //A unique identifier associated to current user e.g. |
| | either a C_RNTI (if already in connected mode) or an identifier associated |
| | to UE's UL pilot channel which can distinguish each user at TRP level. |
| | decision: <Boolean, optional> //This boolean IE is used to inform TRP's |
| | decision to TRP-C/DU. True/yes or False/no to serve user's cluster. In |
| | case of False/no, a TRP may even decide not to send the message at all, |
| | and TRP-C/DU will not consider this TRP for cluster formation in |
| | localized processing scenarios. |
| | } |
| Cluster Decision | Purpose: To inform each cluster candidate TRP that its part of a decided |
| | and designated cluster. |
| | Direction: TRP-C/DU −> TRP (to each cluster candidate TRP) |
| | Interface: FAPI / nFAPI |
| | Message Name: Cluster_Configuration_Info |
| | Structure: |
| | { |
| | clusterCount: <Integer> //An integer to denote TRP that how many cluster |
| | information follows. |
| | { |
| | clusterId: <Integer> //An identifier designated by TRP-C/DU to uniquely |
| | identify a cluster between TRP-C/DU and TRP entities. This identifier |
| | shall be associated to UE context/Id to which the cluster will actually |
| | serve. |
| | feedback: <Boolean, optional> //This boolean IE shall be set to True if |
| | TRP-C/DU expects TRP to Acknowledge that it will serve the designated |
| | cluster/user. In case of local decision making at TRP where TRP sends |
| | their decision beforehand to TRP-C/DU, this field can be optional. |
| | }...//till clusterCount. |
| | } |
| TRP_Ack/Nack” | Purpose: To inform TRP-C/DU about TRPs agreement to serve in a cluster |
| when feedback | as Ack(yes) or Nack(no) in centralized processing scenarios. |
| is expected by | Direction: TRP (from each cluster candidate TRP) −> TRP-C/DU |
| TRP-C/DU | Interface: FAPI / nFAPI |
| | Message Name: TRP_Acknowledgement |
| | Structure: |
| | { |
| | clusterCount: <Integer> //An integer to denote TRP-C/DU that how many |
| | cluster information follows. |
| | { |
| | clusterId: <Integer, optional> //An identifier designated by TRP-C/DU to |
| | uniquely identify a cluster between TRP-C/DU and TRP entities. This |
| | identifier shall be associated to UE context/Id to which the cluster will |
| | actually serve. |
| | feedback: <Boolean> //This boolean IE serves as TRP's acknowledgement |
| | to serve the user's cluster. True as Ack/yes, and False as Nack/no. |
| | }...//till clusterCount. |
| | } |
| | Note: If clusterCount, for which feedback is being sent, is same as |
| | received in Cluster_Configuration_Info, then including clusterId can be |
| | optional and instead just a boolean bitstream of feedback bits can be sent. |
| | It's a design choice. |

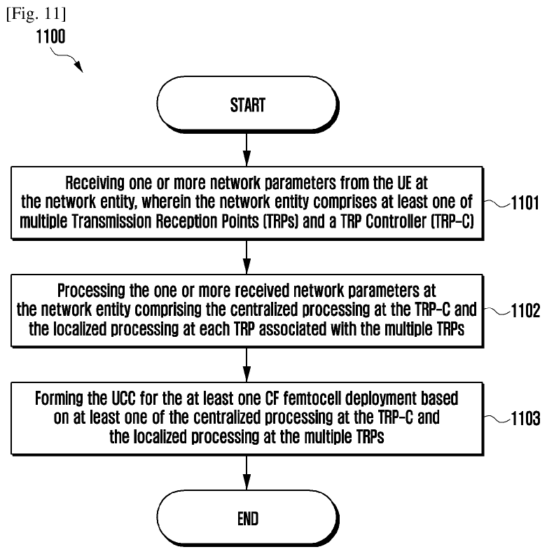

FIG. 11 is a flow diagram illustrating a method 1100 for forming the UCC for the at least one CF femtocell deployment, according to an embodiment as disclosed herein.

At step 1101, the method 1100 includes receiving one or more network parameters from the UE 400 at the network entity 300, wherein the network entity 300 comprises at least one of multiple TRPs (e.g., TRP1 301a, TRP2 302b, etc.) and the TRP-C (e.g., 302). At step 1102, the method 1100 includes processing the one or more received network parameters at the network entity comprising the centralized processing at the TRP-C (e.g., 302) and the localized processing at each TRP associated with the multiple TRPs (e.g., TRP1 301a, TRP2 302b, etc.). At step 1103, the method 1100 includes forming the UCC for the at least one CF femtocell deployment based on at least one of the centralized processing at the TRP-C (e.g., 302) and the localized processing at the multiple TRPs (e.g., TRP1 301a, TRP2 302b, etc.). Further, a detailed description related to the various steps of FIG. 11 is covered in the description related to FIG. 5, FIGS. 6A, 6B, 6C, and 6D, FIG. 7, FIGS. 8A and 8B, FIG. 9, and FIGS. 10A, 10B, 10C, and 10D, and is omitted herein for the sake of brevity.

The disclosed method 1100 offers numerous advantages when compared to established industry standards and prevailing wireless communication systems. Specifically, the disclosed method 1100 furnishes technical solutions for the architecture and cellular cluster formation schemes of 6G cell-free femtocells, thereby facilitating seamless indoor coverage. This positions the method at the forefront, enabling early specification and standardization, while concurrently elevating user coverage and enhancing the overall experience.

The various actions, acts, blocks, steps, or the like in the flow/sequence diagrams may be performed in the order presented, in a different order, or simultaneously. Further, in some embodiments, some of the actions, acts, blocks, steps, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method (1100) for forming a User Centric Cluster (UCC) for at least one Cell Free (CF) femtocell deployment, the method (1100) comprising:
receiving (1101) one or more network parameters from a User Equipment (UE) (400) at a network entity (300), wherein the network entity (300) comprises at least one of multiple Transmission Reception Points (TRPs) and a TRP Controller (TRP-C),
wherein the one or more network parameters comprise Channel State Information Reference Signal (CSI-RS) information, Transmission Configuration Indicator (TCI) state measurement information, Uplink (UL) pilot signal information, and location sensing information;
processing (1102) the one or more received network parameters at the network entity (300) comprising a centralized processing at the TRP-C and a localized processing at each TRP associated with the multiple TRPs; and
forming (1103) the UCC for the at least one CF femtocell deployment based on at least one of the centralized processing at the TRP-C and the localized processing at the multiple TRPs.

2. The method (1100) as claimed in claim 1,
wherein receiving the one or more network parameters from the UE (400) at the TRP-C comprises:
detecting that the UE (400) camped on a first TRP among the multiple TRPs, wherein the UE (400) camped on the first TRP by utilizing a beam sweep procedure;
determining a presence of one or more TRPs within a coverage area of the UE (400) by analyzing an Angle of Arrival (AoA) and an Angle of Departure (AoD) of a current serving beam used by the UE (400);
sending a TCI state measurements request to the UE (400) to determine a first list of TRPs being part of the UCC; and
receiving, upon sending the TCI state measurements request, the one or more network parameters from the UE (400) at the TRP-C comprise the CSI-RS information, the TCI state measurement information associated with the multiple TRPs,
wherein the centralized processing at the TRP-C comprises:
determining load condition information and capacity information of each TRP;
determining an uplink channel condition associated with each TRP, wherein each TRP transmits an UL pilot signal received from the UE (400) along with the determined load condition information, the determined capacity information to the TRP-C and the TRP-C estimates centralized channel for the UL pilot signal; and
determining a first list of TRPs being part of the UCC based on at least one of the determined load condition information, the determined capacity information, and the determined uplink channel condition.

3. The method (1100) as claimed in claim 1, wherein forming the UCC for the at least one CF femtocell deployment based on the centralized processing at the TRP-C comprises:
sending a cluster decision message to each TRP associated with the first list of determined TRPs;
receiving, upon sending the cluster decision message, an acknowledgement message from each TRP associated with the list of determined TRPs comprising a positive acknowledgement message, or a negative acknowledgement message based on load condition information and capacity information;
determining a second list of TRPs being part of the UCC, wherein the TRP-C removes one or more TRPs that send the negative acknowledgement message to the TRP-C;
sending the determined second list of TRPs to the UE (400) to keep active the TRPs that agreed to serve in the UCC through the positive acknowledgement message and deactivate the TRPs that are not agree to serve in the UCC through the negative acknowledgement message by managing the TCI states that are uniquely mapped to each TRP and (de)activation using an Layer 1 (L1) Downlink Control Information (DCI) command or an Layer 2 (L2) Media Access Control Element (MAC CE) command; and
forming, based on the determined second list of TRPs, the UCC for the at least one CF femtocell deployment,
wherein the localized processing at each TRP comprises:
sending a TRP decision message to the TRP-C,
wherein the TRP decision message comprises one of a positive TRP decision message and a negative TRP decision message;
wherein the TRP decision message is determined based on at least one of the load condition information, the capacity information, an Uplink (UL) channel condition and by comparing an UL channel condition of a current UE with an UL channel condition of a previously served UE; and
wherein the TRP-C configures a TCI state reporting framework in the UE (400) by using a Radio Resource Control (RRC) reconfiguration message upon detecting that the UE (400) is camped on a first TRP among the multiple TRPs.

4. The method (1100) as claimed in claim 1, wherein forming the UCC for the at least one CF femtocell deployment based on the localized processing at each TRP comprises:
determining, upon receiving the TRP decision message, a list of TRPs that send the positive TRP decision message;
sending a cluster decision message to one or more TRPs associated with the determined list of TRPs;
receiving, upon sending the cluster decision message, an acknowledgement message from the one or more TRPs;
sending the determined list of TRPs to the UE (400) to keep active the TRPs that agreed to serve in the UCC through the positive acknowledgement message and deactivate the TRPs that are not agree to serve in the UCC through the negative acknowledgement message by managing the TCI states that are uniquely mapped to each TRP and (de)activation using an Layer 1 (L1) Downlink Control Information (DCI) command or an Layer 2 (L2) Media Access Control Element (MAC CE) command; and
forming, based on the determined list of TRPs, the UCC for the at least one CF femtocell deployment,
wherein receiving the one or more network parameters from the UE (400) at the TRP-C comprises:
determining, upon receiving the location sensing information, a current location of the UE (400) by using one or more mechanisms, wherein the one or more mechanisms comprises:
managing a database of serving TRPs at the TRP-C, wherein the TRP-C maintains a record of the UCC for each UE located in an indoor environment, with updates made based on a prior UCC configuration for each UE;
mapping of the serving TRPs based on the current location of the UE (400), wherein the TRP-C assigns the serving TRPs as part of the UCC of the UE (400) based on the current location of the UE (400); and
mapping of the serving TRPs based on the current location of the UE (400),
wherein the TRP-C determines the current location of the UE (400) by utilizing at least one of a communication signal reflection mechanism associated with the UE (400) and a backscatter communication mechanism associated with the UE (400); and
wherein the TRP-C assigns the serving TRPs as part of the UCC of the UE (400) based on the current location of the UE (400).

5. The method (1100) as claimed in claim 1, comprising:
exchanging information between multiple TRP-Cs by using at least one of a switch entity and a DU-DU interface, wherein the information comprises a list of TRPs present in a shared region between multiple TRP-Cs; and
forming, based on the exchanged information, the UCC for the at least one CF femtocell deployment.

6. The method (1100) as claimed in claim 1, wherein the at least one CF femtocell deployment comprises:
deploying a network entity (300) within an indoor environment,
wherein the network entity (300) comprises at least one of Central Unit (CU), or Distributed Unit (DU) functionality;
wherein one or more Remote Units (RUs) are strategically positioned as multiple distributed antennas or TRPs in a systematic layout to provide coverage throughout the indoor environment; and
wherein the network entity (300) is connected to an external 6G Core Network (CN) via a public infrastructure, or linked to a distant CU from a macrocell via an F1 interface, wherein the public infrastructure comprises at least one of an internet connection, routed through a secure Gateway (GW).

7. The method (1100) as claimed in claim 1, wherein the at least one CF femtocell deployment comprises:
deploying one or more network entities within an indoor environment,
wherein each network entity (300) comprises TRP-C functionality;
wherein one or more Remote Units (RUs) are strategically positioned as multiple distributed antennas or TRPs in a systematic layout to provide coverage throughout the indoor environment;
wherein each network entity (300) is linked to a distant Distributed Unit (DU) from a macrocell via a fronthaul link;
wherein the fronthaul link is capable of being either a wired or wireless connection between the distant DU of the macrocell and each network entity (300); and
deploying a switch entity or a DU-DU interface between the one or more deployed network entities to exchange information between multiple TRP-Cs to form the UCC, wherein the information comprises a list of TRPs present in a shared region between multiple TRP-Cs.

8. A system (301) for forming a User Centric Cluster (UCC) for at least one Cell Free (CF) femtocell deployment, wherein the system (301) comprising:
a memory (310);
a communicator (330); and
a processor (320), operably connected to the memory (310) and the communicator (330), the processor (320) is configured to:
receive one or more network parameters from a User Equipment (UE) (400) at a network entity (300), wherein the network entity (300) comprises at least one of multiple Transmission Reception Points (TRPs) and a TRP Controller (TRP-C),
wherein the one or more network parameters comprise Channel State Information Reference Signal (CSI-RS) information, Transmission Configuration Indicator (TCI) state measurement information, Uplink (UL) pilot signal information, and location sensing information;
process the one or more received network parameters at the network entity (300) comprising a centralized processing at the TRP-C and a localized processing at each TRP associated with the multiple TRPs; and
form the UCC for the at least one CF femtocell deployment based on at least one of the centralized processing at the TRP-C and the localized processing at the multiple TRPs.

9. The system (301) as claimed in claim 8,
wherein to receive the one or more network parameters from the UE (400) at the TRP-C, the processor (320) is configured to:
detect that the UE (400) camped on a first TRP among the multiple TRPs, wherein the UE (400) camped on the first TRP by utilizing a beam sweep procedure;
determine a presence of one or more TRPs within a coverage area of the UE (400) by analyzing an Angle of Arrival (AoA) and an Angle of Departure (AoD) of a current serving beam used by the UE (400);
send a TCI state measurements request to the UE (400) to determine a first list of TRPs being part of the UCC; and
receive, upon sending the TCI state measurements request, the one or more network parameters from the UE (400) at the TRP-C comprise the CSI-RS information, the TCI state measurement information associated with the multiple TRPs,
wherein the centralized processing at the TRP-C, the processor (320) is configured to:
determine load condition information and capacity information of each TRP;
determine an uplink channel condition associated with each TRP,
wherein each TRP transmits an UL pilot signal received from the UE (400) along with the determined load condition information, the determined capacity information to the TRP-C and the TRP-C estimates centralized channel for the UL pilot signal; and
determine a first list of TRPs being part of the UCC based on at least one of the determined load condition information, the determined capacity information, and the determined uplink channel condition.

10. The system (301) as claimed in claim 8,
wherein to form the UCC for the at least one CF femtocell deployment based on the centralized processing at the TRP-C, the processor (320) is configured to:
send a cluster decision message to each TRP associated with the first list of determined TRPs;
receive, upon sending the cluster decision message, an acknowledgement message from each TRP associated with the list of determined TRPs comprising a positive acknowledgement message, or a negative acknowledgement message based on load condition information and capacity information;
determine a second list of TRPs being part of the UCC, wherein the TRP-C removes one or more TRPs that send the negative acknowledgement message to the TRP-C;
send the determined second list of TRPs to the UE (400) to keep active the TRPs that agreed to serve in the UCC through the positive acknowledgement message and deactivate the TRPs that are not agree to serve in the UCC through the negative acknowledgement message by managing the TCI states that are uniquely mapped to each TRP and (de)activation using an Layer 1 (L1) Downlink Control Information (DCI) command or an Layer 2 (L2) Media Access Control Element (MAC CE) command; and
form, based on the determined second list of TRPs, the UCC for the at least one CF femtocell deployment,
wherein the localized processing at each TRP, the processor (320) is configured to:
send a TRP decision message to the TRP-C,
wherein the TRP decision message comprises one of a positive TRP decision message and a negative TRP decision message;
wherein the TRP decision message is determined based on at least one of the load condition information, the capacity information, an Uplink (UL) channel condition and by comparing an UL channel condition of a current UE with an UL channel condition of a previously served UE; and
wherein the TRP-C configures a TCI state reporting framework in the UE (400) by using a Radio Resource Control (RRC) reconfiguration message upon detecting that the UE (400) is camped on a first TRP among the multiple TRPs.

11. The system (301) as claimed in claim 8, wherein forming the UCC for the at least one CF femtocell deployment based on the localized processing at each TRP, the processor (320) is configured to:
determine, upon receiving the TRP decision message, a list of TRPs that send the positive TRP decision message;
send a cluster decision message to one or more TRPs associated with the determined list of TRPs;
receive, upon sending the cluster decision message, an acknowledgement message from the one or more TRPs;
send the determined list of TRPs to the UE (400) to keep active the TRPs that agreed to serve in the UCC through the positive acknowledgement message and deactivate the TRPs that are not agree to serve in the UCC through the negative acknowledgement message by managing the TCI states that are uniquely mapped to each TRP and (de)activation using an Layer 1 (L1) Downlink Control Information (DCI) command or an Layer 2 (L2) Media Access Control Element (MAC CE) command; and
form, based on the determined list of TRPs, the UCC for the at least one CF femtocell deployment.

12. The system (301) as claimed in claim 8, wherein receiving the one or more network parameters from the UE (400) at the TRP-C, the processor (320) is configured to:
determine, upon receiving the location sensing information,
a current location of the UE (400) by using one or more mechanisms, wherein the one or more mechanisms comprises:
managing a database of serving TRPs at the TRP-C, wherein the TRP-C maintains a record of the UCC for each UE located in an indoor environment, with updates made based on a prior UCC configuration for each UE;
mapping of the serving TRPs based on the current location of the UE (400), wherein the TRP-C assigns the serving TRPs as part of the UCC of the UE (400) based on the current location of the UE (400); and
mapping of the serving TRPs based on the current location of the UE (400),
wherein the TRP-C determines the current location of the UE (400) by utilizing at least one of a communication signal reflection mechanism associated with the UE (400) and a backscatter communication mechanism associated with the UE (400); and
wherein the TRP-C assigns the serving TRPs as part of the UCC of the UE (400) based on the current location of the UE (400).

13. The system (301) as claimed in claim 8, the processor (320) is configured to:
exchange information between multiple TRP-Cs by using at least one of a switch entity and a DU-DU interface, wherein the information comprises a list of TRPs present in a shared region between multiple TRP-Cs; and
form, based on the exchanged information, the UCC for the at least one CF femtocell deployment.

14. The system (301) as claimed in claim 8, wherein the at least one CF femtocell deployment, the processor (320) is configured to:
deploy a network entity (300) within an indoor environment,
wherein the network entity (300) comprises at least one of Central Unit (CU), or Distributed Unit (DU) functionality;
wherein one or more Remote Units (RUs) are strategically positioned as multiple distributed antennas or TRPs in a systematic layout to provide coverage throughout the indoor environment; and
wherein the network entity (300) is connected to an external 6G Core Network (CN) via a public infrastructure, or linked to a distant CU from a macrocell via an F1 interface, wherein the public infrastructure comprises at least one of an internet connection, routed through a secure Gateway (GW).

15. The system (301) as claimed in claim 8, wherein the at least one CF femtocell deployment, the processor (320) is configured to:
deploy one or more network entities within an indoor environment,
wherein each network entity (300) comprises TRP-C functionality;
wherein one or more Remote Units (RUs) are strategically positioned as multiple distributed antennas or TRPs in a systematic layout to provide coverage throughout the indoor environment;
wherein each network entity (300) is linked to a distant Distributed Unit (DU) from a macrocell via a fronthaul link;
wherein the fronthaul link is capable of being either a wired or wireless connection between the distant DU of the macrocell and each network entity (300); and
deploying a switch entity or a DU-DU interface between the one or more deployed network entities to exchange information between multiple TRP-Cs to form the UCC, wherein the information comprises a list of TRPs present in a shared region between multiple TRP-Cs.
